(19) United States
(12) Patent Application Publication
(10) Pub. No.: US 2015/0112576 A1
(43) Pub. Date: Apr. 23, 2015

(54) PUMP CONTROL APPARATUS FOR FUEL SUPPLY SYSTEM OF FUEL-INJECTION ENGINE

(71) Applicant: DENSO CORPORATION, Kariya-city (JP)

(72) Inventor: Kazumasa WATANABE, Kariya-shi (JP)

(21) Appl. No.: 14/519,674

(22) Filed: Oct. 21, 2014

(30) Foreign Application Priority Data
Oct. 22, 2013 (JP) 2013-219221

(51) Int. Cl. F02D 41/38; F02D 41/14

(52) U.S. Cl. CPC F02D 41/3845; F02D 41/1401
USPC 701/104

(57) ABSTRACT

An estimated fuel consumption quantity corresponding to a fuel injection timing of an engine is reduced or set to zero if failure of the corresponding injector has been detected. A pump control apparatus controls a fuel supply pump to maintain the pressure in a common rail at a target value by control of a command delivery quantity supplied from the pump to the common rail in correspondence with each injection timing. Each command delivery quantity is determined based on a necessary delivery quantity and on a feedback quantity, which is derived from a difference between previously obtained values of command delivery quantity and of a corresponding actual delivery quantity from the pump. Prior to the injection, a pressure compensation quantity is calculated, as a fuel quantity required to bring the fuel rail pressure to the target pressure value, and is added to the fuel consumption quantity to obtain the necessary delivery quantity.

### CROSS-REFERENCE TO RELATED APPLICATIONS

This application is based on and incorporates herein by reference Japanese Patent First Application No. 2013-219221 filed on Oct. 22, 2013.

### BACKGROUND OF THE INVENTION

1. Field of Application

The present invention relates to a pump control apparatus for application to a fuel supply system of an internal combustion engine (referred to in the following simply as an engine), whereby fuel is delivered from a fuel supply pump to be stored under pressure in a common rail, and supplied from the common rail to respective fuel injectors of the engine cylinders.

2. Description of Related Art

With such a fuel supply system, the fuel supply pump (high-pressure fuel pump) repetitively impels a controlled quantity of fuel (referred to in the following as a pumping quantity) into the common rail. Types of control apparatus for such a fuel supply system are known whereby the fuel pressure within the common rail (referred to in the following as the common rail pressure) is held at a target pressure value, by feedback control of the pumping quantity based on the difference between the common rail pressure and the target pressure value.

However with such a type of control apparatus, when the target pressure value becomes changed due to a change in the running conditions of the engine, the common rail pressure may overshoot the target pressure value, or hunting may occur.

To avoid this, technology is known whereby instead of performing feedback control of the pumping quantity supplied from the fuel supply pump based on the difference between the common rail pressure and the target pressure value, values of a necessary delivery quantity (quantity of fuel required to be delivered from the fuel supply pump for setting the common rail pressure at the target pressure value) are repetitively determined. Feedback control of the fuel supplied from the fuel supply pump is performed based on the difference between each necessary delivery quantity and a corresponding quantity of fuel which actually flows from the fuel supply pump into the common rail.

Each necessary delivery quantity value is calculated using a fuel consumption quantity (estimated quantity of fuel consumed by a fuel injector in executing an injection) as a parameter. Each fuel consumption quantity is calculated using a corresponding command injection quantity as a parameter, where a command injection quantity is the quantity of fuel designated (e.g., by the engine ECU) to be injected at an injection timing.

However if failure of a fuel injector occurs, then each quantity of fuel delivered from the fuel injector may be substantially less than the corresponding command injection quantity, or zero. If each value of necessary delivery quantity is estimated based on a corresponding estimated fuel consumption quantity, then the necessary delivery quantity values will be excessively large. Thus, accurate feedback control of the quantities of fuel delivered to the common rail from the fuel supply pump will not be possible.

A fuel supply pump control system described in Japanese patent publication 2000-110612, (referred to in the following as reference 1) is relevant to the present invention, although not specifically directed to the above problem resulting from fuel injector failure. Reference 1 is concerned with a fuel injection type of engine and a fuel supply pump control system that is selectively operable in a half-cylinder mode in which fuel injections are performed by only half of the fuel injectors of the engine and an all-cylinder mode in which fuel injections are performed by all of the fuel injectors.

For each injection timing of a cylinder, a decision is made as to whether the engine is currently operating in the all-cylinder mode or the half-cylinder mode. If in the all-cylinder mode, the fuel consumption quantity for that injection timing is estimated based on the corresponding command injection quantity. However if the engine is judged to be currently operating in the half-cylinder mode, the fuel consumption quantity is set as half of the command injection quantity. The resultant fuel quantity impelled from the fuel supply pump (i.e., as determined based on the fuel consumption quantity) is thereby reduced by half, by comparison with the case of all-cylinder operation. That is, each estimated fuel consumption quantity is reduced in proportion to the ratio of the number of functioning injectors when operating in the half-cylinder mode to the number of functioning injectors when operating in the all-cylinder mode.

While an assumed relationship between a total quantity of fuel injected by all of the fuel injectors of the engine and a corresponding total quantity of fuel required to be supplied to the common rail for maintaining the common rail pressure at a target pressure value may be valid, it is not necessarily appropriate for determining the relationship between each fuel consumption quantity of an individual injector and the corresponding quantity of fuel required to be delivered into the common rail, for maintaining the common rail pressure at the target pressure value. Thus it might not be possible to maintain the common rail pressure at the target pressure value, if the method proposed in reference 1 were to be applied to the problem of possible failure of a fuel injector of an engine.

### SUMMARY OF THE INVENTION

Hence it is desired to overcome the above problem by providing a pump control apparatus for a fuel supply system of an internal combustion engine having fuel injectors installed in respective engine cylinders, receiving fuel from a common rail which is supplied from a common rail, whereby the common rail pressure is correctly controlled to a target pressure value irrespective of whether or not failure of a fuel injector has occurred.

Such a pump control apparatus comprises injection condition detection means, consumption quantity determining means, compensation quantity determining means, necessary delivery quantity determining means, actual delivery quantity detection means, feedback means, command delivery quantity determining means, and pump control means.

Prior to each injection timing of each of the fuel injectors, the consumption quantity determining means calculates a fuel consumption quantity and the compensation quantity determining means calculates a pressure compensation quantity. The fuel consumption quantity is the estimated quantity of fuel which will be consumed by the injection. The pressure compensation quantity is a quantity of fuel estimated which would be required (at the current time point) to be supplied to the common rail for setting the common rail pressure at a target pressure value. The pressure compensation quantity is calculated based on the difference between the common rail pressure and the target pressure value at that time.

The necessary delivery quantity determining means determines, prior to each fuel injection, a necessary delivery quantity based on the total of the fuel consumption quantity and pressure compensation quantity. This is the a fuel quantity estimated as being required to be impelled into the common rail from the fuel supply pump on completion of the fuel injection, for restoring the common rail pressure to the target pressure value.

The actual delivery quantity detection means detects an actual delivery quantity, for each injection timing. This is a detected quantity of fuel actually impelled into the common rail by the fuel supply pump, following an injection. The feedback means calculates a feedback quantity, which is a fuel quantity calculated based on the difference between the values of necessary delivery quantity and actual delivery quantity which were obtained for the preceding injection timing of the fuel injector concerned.

The command delivery quantity determining means determines a command delivery quantity prior to each injection timing, as the sum of the necessary delivery quantity and feedback quantity. The pump control means controls the fuel supply pump to impel a quantity of fuel equal to the command delivery quantity into the common rail subsequent to the injection timing. Each command delivery quantity may be delivered as a single pumping quantity or as a plurality of pumping quantities.

The injection condition detection means detects the injection condition of each fuel injector. The consumption quantity determining means determines the fuel consumption quantity based on the command injection quantity in conjunction with the detected injection condition of the fuel injector concerned, e.g., with the fuel consumption quantity being determined as zero, if failure of the fuel injector has been detected.

It can thereby be ensured that accurate values of fuel consumption quantity can be estimated even when a fuel injector is functioning abnormally. This ensures that an appropriate command quantity of fuel can be reliably impelled to the common rail from the fuel supply pump after each injection timing. The common rail pressure can thereby be reliably set at the target pressure value prior to each injection timing.

The injection condition detection means may detect the injection condition of a fuel injector based on an actual injection quantity delivered by the fuel injector, e.g., detected based on the extent of a change in engine speed during a fuel injection.

Alternatively, the injection condition detection means may detect the injection condition based on a difference between a command injection quantity and the corresponding actual injection quantity, or based on the ratio of an actual fuel injection quantity to the corresponding command injection quantity.

As a further alternative, the injection condition detection means may detect the injection condition of a fuel injector based on a condition of mechanical operation of the fuel injector, or on a condition of electrical operation of the fuel injector, for example an open-circuit or short-circuit in a connecting lead which supplies a command signal to the fuel injector.

### BRIEF DESCRIPTION OF THE DRAWINGS

FIG. 1 is a block diagram showing the general configuration of a fuel supply system incorporating an embodiment of a fuel supply pump control apparatus;

FIGS. 2A, 2B are diagrams illustrating the functioning of a fuel supply pump of the embodiment;

FIGS. 3A and 3B are timing diagrams respectively illustrating fuel supply pump control operation of the embodiment and an example of prior art fuel supply pump control operation;

FIG. 4 is a flow diagram of a first form of pump control processing which is applicable to the embodiment;

FIG. 5 is a flow diagram of a second form of pump control processing which is applicable to the embodiment; and,

FIG. 6 is a flow diagram of a third form of pump control processing which is applicable to the embodiment.

### DESCRIPTION OF PREFERRED EMBODIMENTS

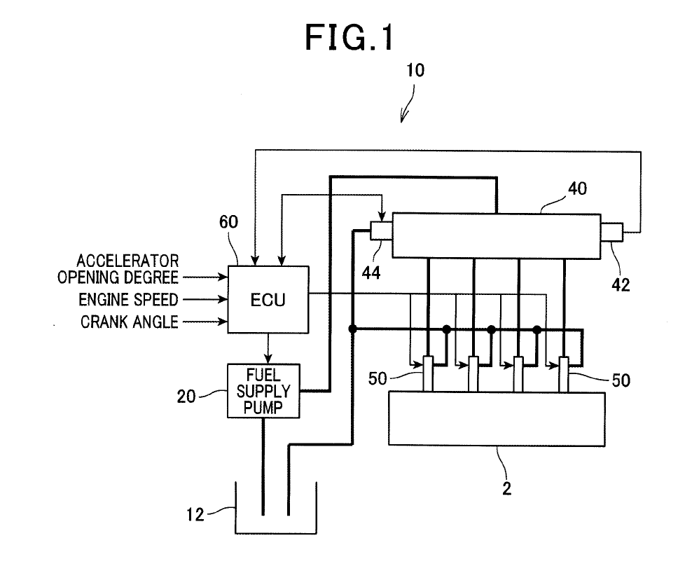

FIG. 1 is a block diagram showing the general configuration of an embodiment of a fuel supply system, designated by numeral 10. The fuel supply system 10 injects fuel into respective cylinders of an engine 2, which is a 4-cylinder diesel engine of a vehicle. As shown the fuel supply system 10 includes a fuel supply pump 20, a common rail 40, a fuel injector 50 and a ECU 60.

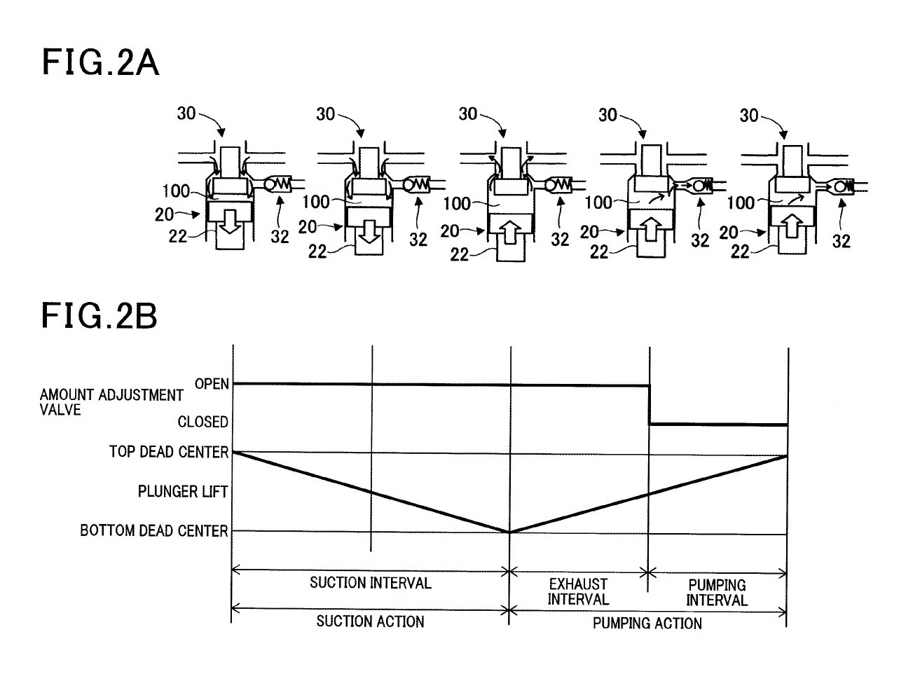

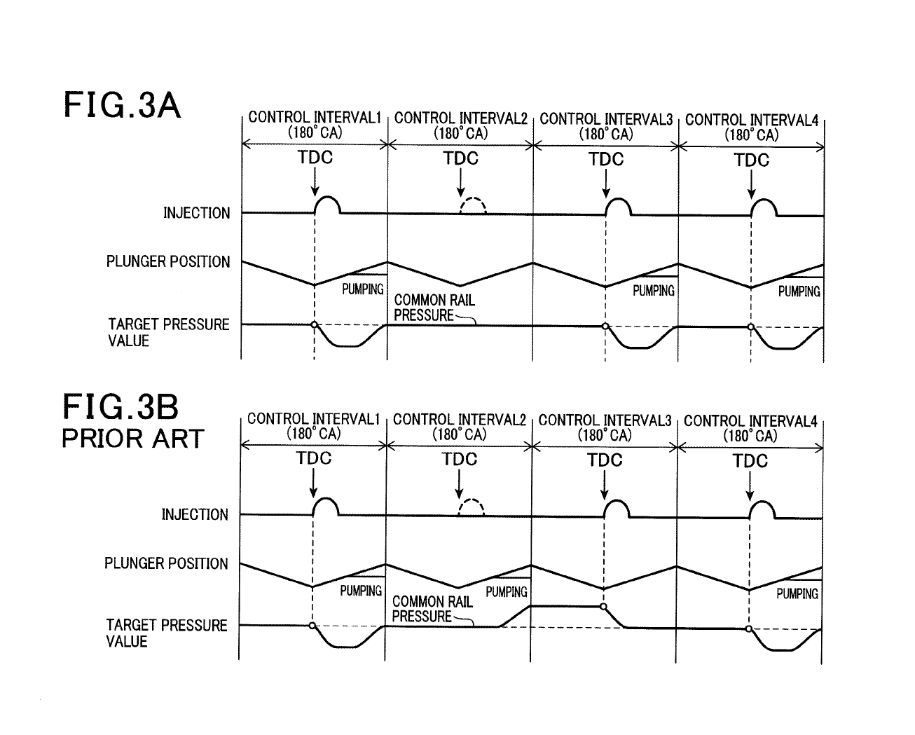

The fuel supply pump 20 incorporates a feed pump which withdraws fuel from a fuel tank 12. The operation of the fuel supply pump 20 is illustrated in FIGS. 2A and 2B. A plunger 22 of the fuel supply pump 20 performs reciprocating motion within a pressure chamber 100, actuated by a cam (not shown in the drawings) which is mounted on a camshaft that is driven from the crankshaft of the engine 2. Fuel is thereby alternately drawn into the pressure chamber 100 of the fuel supply pump 20 from the feed pump, then impelled from the pressure chamber 100 into the common rail 40. An interval corresponding to one cycle of operation of the fuel supply pump 20, in which a fuel suction action and a fuel pumping action successively occur as shown in the timing diagram of FIG. 2B, will be referred to as a control interval of the fuel supply pump 20. The timing diagram of FIG. 3 illustrates the relationship between successive control intervals and fuel injections executed in respective cylinders of the engine 2, Each control interval corresponds to one injection timing, and (with a 4-cylinder engine) corresponds to 180° CA (crankshaft rotation angle) of the engine 2.

As shown in FIG. 2A a quantity pump control valve 30 is located at the suction side of the fuel supply pump 20, with timings of opening and closing of the quantity pump control valve 30 being controlled by the ECU 60. The quantity pump control valve 30 is an electrically operated valve, held in a normally open condition when current is not supplied, with current being supplied only during each pumping interval, shown in FIG. 2B. The quantity pump control valve 30 is set in the open state at the start of each control interval, so that the duration of each pumping interval (in which a pumping quantity of fuel is delivered from the fuel supply pump 20 to the common rail 40) is determined by the closing timings of the quantity pump control valve 30, i.e., the pumping quantity is regulated by adjusting these closing timings.

The quantity pump control valve 30 uses an actuator which with this embodiment is of solenoid type, however a piezoelectric type of actuator, etc., may equally be used.

A reverse flow discharge valve 32 is located at the discharge (high-pressure) side of the fuel supply pump 20, for enabling fuel flow from the pressure chamber 100 to the common rail 40 while preventing fuel from passing back under pressure from the common rail 40 into the pressure chamber 100.

As shown in FIG. 2B, a suction action (extending from the point at which the plunger 22 is at the top dead center position until it reaches the bottom dead center position) and a pumping action (from the bottom dead center position back to the top dead center position) successively occur in each control interval. During a suction action the supplying of current to the quantity pump control valve 30 is interrupted, so that the quantity pump control valve 30 is held in the open state. The quantity of fuel held in the pressure chamber 100 is thereby increased throughout the suction interval as fuel supplied from the feed pump becomes drawn into the pressure chamber 100.

In an initial part of the pumping action, designated as the exhaust interval, supplying of current to the quantity pump control valve 30 continues to be interrupted, so that the quantity pump control valve 30 remains open. As a result, some fuel is ejected from the pressure chamber 100 through the suction side of the fuel supply pump 20, via the quantity pump control valve 30, back into the fuel tank 12 during the exhaust interval.

The exhaust interval ends at a conduction start timing (i.e., closing timing of the quantity pump control valve 30) when the camshaft of the fuel supply pump 20 reaches a specific rotation angle, and a pumping interval then commences. Supplying of current to the quantity pump control valve 30 is commenced at the conduction start timing, thereby closing the quantity pump control valve 30 until the end of the control interval. Pressure of the fuel within the pressure chamber 100 thereby begins to increase, and when that pressure exceeds the common rail pressure, fuel from the pressure chamber 100 is impelled through the reverse flow discharge valve 32 into the common rail 40.

Hence by controlling the conduction start timing of the quantity pump control valve 30 in each control interval, the quantity of fuel (pumping quantity) supplied to the common rail 40 in each pumping action can be regulated. The earlier the conduction start timing the greater is the pumping quantity, and the later the conduction start timing, the smaller is the pumping quantity.

As illustrated in the timing diagram of FIG. 3A, if a fuel injection is executed in a control interval, a single corresponding pumping quantity is delivered from the fuel supply pump 20 to the common rail 40 following that fuel injection, i.e., there is a 1:1 relationship between fuel injections and pumping quantities.

The common rail 40 shown in FIG. 1 is a hollow vessel which stores fuel delivered from the fuel supply pump 20 under pressure. A pressure sensor 42 which detects the common rail pressure and a pressure reduction valve 44 which lowers the common rail pressure when necessary (by enabling fuel to flow from the common rail 40 back into the fuel tank 12) are installed on the common rail 40.

Fuel injectors 50 are installed in respective cylinders of the engine 2, and inject the fuel stored in the common rail 40 into the cylinders at respective injection timings. Each fuel injector 50 is of known type, i.e., in which opening/closing of an injection aperture by lifting of a nozzle needle is controlled by the pressure in a control chamber. The quantity of fuel injected by a fuel injector 50 in an injection operation is determined by an injection command signal which is transmitted to that injector from the ECU 60. The injection command signal is a variable-width pulse, with increase of pulse width corresponding to increase of a command injection quantity (quantity of fuel specified to be injected).

The ECU 60 basically consists of a microcomputer having a CPU, RAM, ROM, flash memory, etc. The CPU of the ECU 60 executes a program which is held stored in the ROM or flash memory, to perform various control operations of the fuel supply system 10, based on detection signals received from sensors including the pressure sensor 42, an engine speed sensor which detects the rotation speed (NE) of the engine 2 (not shown in the drawings), an accelerator opening degree sensor (not shown in the drawings), etc.

In each control interval, the ECU 60 determines the pumping start timing of the fuel supply pump 20 such that the pumping quantity delivered to the common rail 40 from the fuel supply pump 20 in that control interval (the command delivery quantity) will bring the common rail pressure to the target pressure value, and sets the conduction start timing of the quantity pump control valve 30 accordingly.

The ECU 60 incorporates a characteristic map (memory map) stored in the ROM or flash memory, derived by measurements performed beforehand, expressing a correlation between values of the pumping quantity and values of the pumping start timing as expressed by the engine crankshaft angle. In each control interval, the ECU 60 sets the conduction start timing of the quantity pump control valve 30 of the fuel supply pump 20 based on a pumping start timing which is acquired using the characteristic map, to thereby control the pumping quantity delivered by the fuel supply pump 20.

The ECU 60 also incorporates a plurality of memory maps stored in the ROM or flash memory, referred to as TQ maps, each expressing the correlation between values of the pulse width (T) of the injection command signal and values of injection quantity (Q). The plurality of TQ maps correspond to respectively different ranges of common rail pressure.

The ECU 60 determines each fuel injection quantity based on the engine speed and accelerator opening degree, then refers to the TQ map which corresponds to the pressure range containing the value of common rail pressure that is currently detected by the pressure sensor 42, and acquires from that TQ map the pulse width for the injection command signal that is to be supplied to the corresponding injector 50.

### Outline of Pump Control Processing

Based on the operating condition of the engine 2 (engine speed, accelerator opening degree, etc.,) and on information (memory maps, etc.,) stored beforehand in the ROM, the ECU 60 controls the injection quantities of the fuel injectors 50 while also determining a target value for the common rail pressure, and controls the quantity pump control valve 30 and the pressure reduction valve 44 to maintain the common rail pressure at the target pressure value.

That is, in each control interval (i.e., with respect to each fuel injection timing of a fuel injector) the ECU 60 determines a necessary delivery quantity as the quantity of fuel required to be supplied to the common rail 40 for bringing the common rail pressure to the target pressure value, and also detects an actual delivery quantity, i.e., a corresponding actual quantity of fuel which flows from the fuel supply pump 20 into the common rail 40. The ECU 60 also calculates a fuel quantity referred to as the F/B (feedback) delivery quantity, based on a difference between the actual delivery quantity and necessary delivery quantity which were derived for the preceding fuel injection. The F/B delivery quantity value is then added to the necessary delivery quantity value calculated for the current injection, to obtain a corresponding command delivery quantity, and the fuel supply pump 20 is controlled to impel that command delivery quantity of fuel into the common rail 40 following the current injection.

When the necessary delivery quantity derived for a control interval is greater than 0, the command delivery quantity is set as the total of the necessary delivery quantity and the F/B delivery quantity, however if the necessary delivery quantity takes a negative value, the ECU 60 leaves the quantity pump control valve 30 continuously in the open condition throughout the pumping action of that control interval, so that the actual delivery quantity is zero, and opens the pressure reduction valve 44.

With this embodiment, both the fuel supply pump 20 and the pressure reduction valve 44 are operated by PID (proportional-integral-derivative) control. A gain factor which is applied in determining each F/B delivery quantity for controlling the fuel supply pump 20, and a gain factor which is applied in determining each F/B delivery quantity for controlling the pressure reduction valve 44, are set respectively independently. Each of the control intervals corresponds to an injection timing of a specific cylinder of the engine 2, and one pumping quantity is delivered from the fuel supply pump 20 to the common rail 40 for each fuel injection. Each fuel injection may be of multi-injection type, i.e., including a pre-injection and a post-injection before/after a main injection.

### Determination of Necessary Delivery Quantity

In the current control interval, prior to the injection timing in that control interval, the ECU 60 calculates a fuel consumption quantity (quantity of fuel that will be consumed by the corresponding injector 50 in that control interval) as the sum of the command injection quantity and a leakage quantity (estimated quantity of fuel that will leak from the fuel injector 50, without being injected into the corresponding engine cylinder).

That is, if failure of the fuel injector 50 has not been detected (as described hereinafter), the ECU 60 assumes that the quantity of fuel which will be injected at the injection timing will be the command injection quantity. The fuel leakage quantity is estimated based upon the injection interval (duration of the fuel injection), the fuel temperature, fuel pressure, etc., as parameters, used in conjunction with memory maps that have been stored beforehand in the ROM of the ECU 60.

The fuel leakage quantity is made up of a small quantity of fuel which passes through the gap between the nozzle needle and the body of the fuel injector 50 (i.e., a gap which is necessary to permit sliding motion of the nozzle needle) to the low-pressure side of the fuel injector 50, fuel which escapes from the control chamber to the low-pressure side when the nozzle needle moves to the open position, etc.

The ECU 60 also (prior to the injection timing) calculates a pressure compensation quantity, based on the difference between the target value of common rail pressure and the actual common rail pressure (as detected by the pressure sensor 42). This is the quantity of fuel which would be required to be supplied to the 40×, at that time, for setting the common rail pressure at the target pressure value.

The sum of the pressure compensation quantity and the fuel consumption quantity is then calculated, as the necessary delivery quantity. The ECU 60 registers the currently obtained value of necessary delivery quantity and of actual delivery quantity, for use in calculating a F/B delivery quantity in the succeeding control interval of the fuel injector 50 (i.e., of the corresponding ro engine cylinder). The F/B delivery quantity for the current control interval is then calculated (using the values of necessary delivery quantity and actual delivery quantity from the preceding control interval of the fuel injector 50), and added to the value of necessary delivery quantity calculated for the current control interval, to obtain the command delivery quantity. The fuel supply pump 20 is then controlled to impel a fuel quantity equal to the command delivery quantity into the common rail 40, following the fuel injection timing of that control interval, as illustrated in FIG. 3A.

If the necessary delivery quantity is negative, the ECU 60 leaves the quantity pump control valve 30 in the open state and reduces the common rail pressure by opening the pressure reduction valve 44.

### Detection of Actual Delivery Quantity

When fuel is supplied from the fuel supply pump 20 to the common rail 40, the fuel pressure within the common rail 40 increases accordingly, and conversely when fuel passes out from the common rail 40 due to an injection operation by a fuel injector 50, the common rail pressure decreases accordingly.

The ECU 60 detects the actual delivery quantity (the pumping quantity that is actually delivered from the fuel supply pump 20 to the common rail 40 in the current control interval) based on a quantity of change in the common rail pressure when the fuel injector 50 performs fuel injection, and on the corresponding fuel consumption quantity.

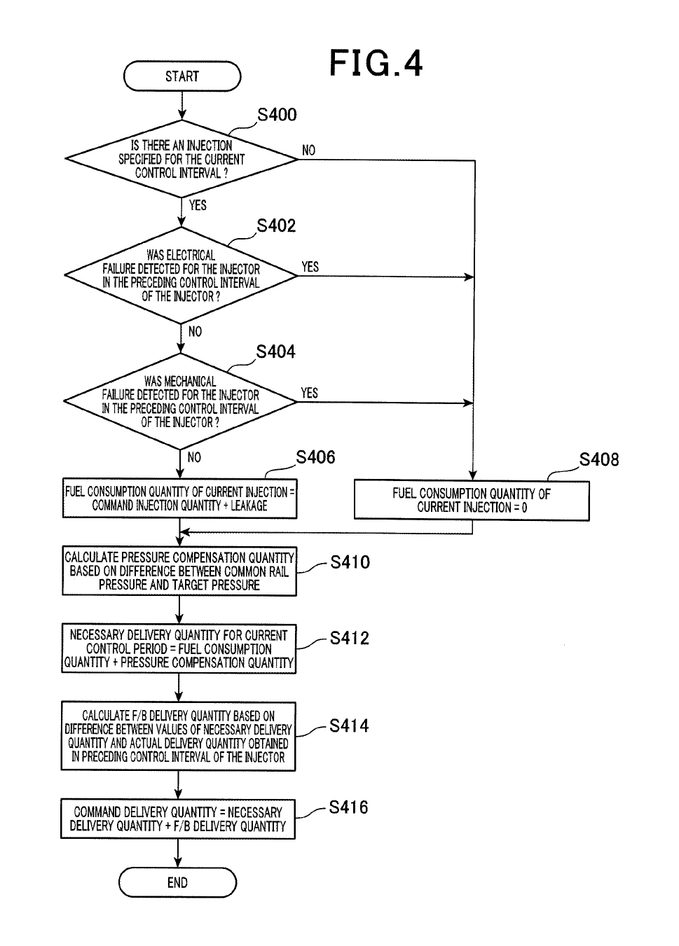

Pump control processing executed by the ECU 60 for controlling the pumping quantity (command delivery quantity) delivered by the fuel supply pump 20 to the common rail 40 in a control interval is described in the following. The pump control processing may be implemented as one of three processing routines, designated as pump control processing 1, pump control processing 2 and pump control processing 3, respectively shown in the flow diagrams of FIGS. 4, 5 and 6. The pump control processing is executed in each control interval before the piston of the engine cylinder corresponding to that control interval reaches the TDC position, i.e., before the injection timing of that control interval.

### Pump Control Processing 1

Firstly (step S400 of FIG. 4) the ECU 60 determines whether the fuel injector 50 will be required to perform fuel injection in the current control interval. A condition in which fuel injection is not required may be, for example, when the engine speed is to be reduced by halting fuel injections, or when injections are performed in a reduced number of cylinders.

If fuel injection is not required (NO in step S400) step S408 is then executed, while if fuel injection is required (YES in step S400) step S402 is executed. In step S402, a decision is made as to whether an electrical failure was detected in the injection condition of the fuel injector 50 in the preceding control interval. Such an electrical failure can for example be due to a short-circuit or a broken connecting lead, causing the drive signal of that injector 50 to be held at a fixed level.

If an electrical failure has been detected (YES in step S402), step S408 is then executed, while if not (NO in step S402), step S404 is then executed, in which a decision is made as to whether a mechanical failure was detected in the injection condition of the fuel injector 50.

A mechanical failure of a fuel injector 50 is a condition whereby the fuel injector 50 cannot mechanically operate, for example due to some foreign material becoming lodged in the fuel injector and so preventing fuel injection. Such a mechanical failure condition can be detected for example, during a control interval, by the quantity of variation in engine speed during that control interval being less than a predetermined value.

If a mechanical failure of the fuel injector 50 has been detected (YES in step S404), step S408 is then executed, while if not (NO in step S404), step S406 is then executed. In step S406, the ECU 60 calculates the fuel consumption quantity (described above) of the fuel injector 50 in the current control interval, using equation (1) below, then step S410 is executed.

Fuel consumption quantity=command injection quantity+leakage quantity (1)

In step S408, the ECU 60 sets the fuel consumption quantity as 0, then step S410 is executed.

In step S410, the ECU 60 calculates a pressure compensation quantity based on the difference between the common rail pressure and the target pressure value in the current control interval (i.e., prior to the injection timing). The pressure compensation quantity is the estimated fuel quantity required (at the time of executing the processing of FIG. 4) to be supplied to the common rail 40 for bringing the common rail pressure to the target pressure value.

Next (step S412), the ECU 60 adds the pressure compensation quantity to the fuel consumption quantity obtained in step S406, to obtain the value of necessary delivery quantity for the current control interval, and registers that value for use in executing step S414 in the succeeding control interval of the fuel injector concerned.

Step S414 is then executed, in which the ECU 60 calculates the F/B delivery quantity required to bring the common rail pressure to the target pressure value. This calculation is based on the difference between the values of necessary delivery quantity and actual delivery quantity respectively obtained in the preceding control interval of the fuel injector 50.

Step S416 is then executed, in which the ECU 60 calculates the command delivery quantity by adding the F/B delivery quantity calculated in step S414 to the necessary delivery quantity calculated in step S412, and supplies an injection command signal to the fuel supply pump 20 for impelling the command fuel quantity into the common rail 40, by control of the quantity pump control valve 30.

Although not shown in the drawings, the actual delivery quantity (pumping quantity delivered from the fuel supply pump 20 to the common rail 40) for the current control interval is detected as described above, subsequent to the injection timing. That value of actual delivery quantity is then registered, for use in executing step S414 in the succeeding control interval of the fuel injector concerned.

With the pump control processing 1, if it has been detected that there is an electrical failure or a mechanical failure of the fuel injector 50, it is ensured that this will not result in the common rail pressure becoming excessively high, as illustrated for the control interval 2 in FIG. 3A. As shown, since the fuel injector 50 corresponding to control interval 2 is defective and so does not inject fuel at the injection timing, the fuel supply pump 20 is prevented from delivering a pumping quantity, i.e., the command delivery quantity is zero.

It is thereby ensured that the common rail pressure remains at the target pressure value by the end of control interval 2, as illustrated in FIG. 3A. Hence, fuel injection is performed normally for the next cylinder of the firing sequence, in control interval 3.

However as illustrated by the comparison example in FIG. 3B, if the failure condition of the fuel injector 50 corresponding to control interval 2 is not detected, a pumping quantity will be delivered to the common rail 40 in control interval 2, irrespective of the fact that no fuel is actually injected at the injection timing. The common rail pressure is thereby substantially above the target pressure value at commencement of control interval 3. Hence the fuel injector 50 of the next cylinder in the firing sequence will perform fuel injection under an excessively high pressure.

It will be understood that the results obtained by pump control processing 1 are based on the fact that feedback control of fuel supplied to the common rail 40 (control of the command flow quantities) is executed respectively separately for each of the fuel injectors 50, and that each command delivery quantity is compensated by a quantity (pressure compensation quantity) which is determined based on any difference that is detected between the common rail pressure and target pressure value prior to a fuel injection corresponding to that command delivery quantity.

### Pump Control Processing 2

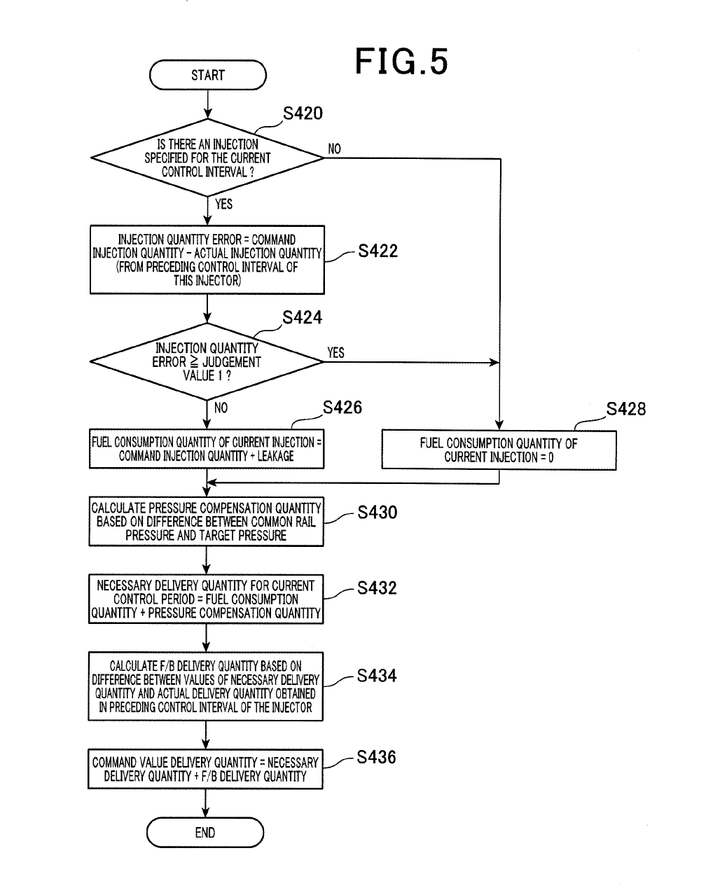

Pump control processing 2 will be described referring to the flow diagram of FIG. 5. Steps S420, 428 and steps S426 to S436 are respectively identical to steps S400, 408 and S406 to S416 in the flow diagram of FIG. 4, so that description of these is omitted.

With this pump control processing, the values of command injection quantity and actual injection quantity which are obtained in the current control interval of a fuel injector 50 are registered by the ECU 60, for use in the succeeding control interval of that injector 50.

If an injection is to be performed in the current control interval (YES in step S420) the ECU 60 applies equation (2) below to calculate an injection quantity error which arose in the preceding control interval of that injector (step S422). The injection quantity error is indicative of the injection condition of the fuel injector 50, and is the difference between the values of command injection quantity and actual injection quantity obtained in the preceding control interval of that injector, i.e.:

Injection quantity error=command injection quantity−actual injection quantity (2)

The actual injection quantity can be detected, for example, based on the extent of a variation in engine speed which occurs when the injection is performed.

The ECU 60 then judges whether the injection quantity error exceeds a predetermined value, designated as judgement value 1 (step S424).

If the injection quantity error does not exceed judgement value 1 (NO in step S424), the ECU 60 judges that fuel was injected normally by the fuel injector 50, and step S426 is then executed. If the injection quantity error exceeds the judgement value 1 (YES in step S424), the ECU 60 judges that the fuel injector 50 injected an insufficient quantity of fuel and so is not functioning normally, and step S428 is then executed.

The magnitude of judgement value 1 is determined such as to enable a condition to be detected in which the actual injection quantity is less than the command injection quantity by a specific quantity, e.g., is less by 90% or more.

Hence, with the pump control processing, a decision is made as to whether the fuel injector 50 corresponding to the current control interval is functioning abnormally, based on the difference between a command injection quantity and an actual injection quantity (precedingly determined). This enables abnormal operation which cannot be detected by the pump control processing 1 to be detected.

### Pump Control Processing 3

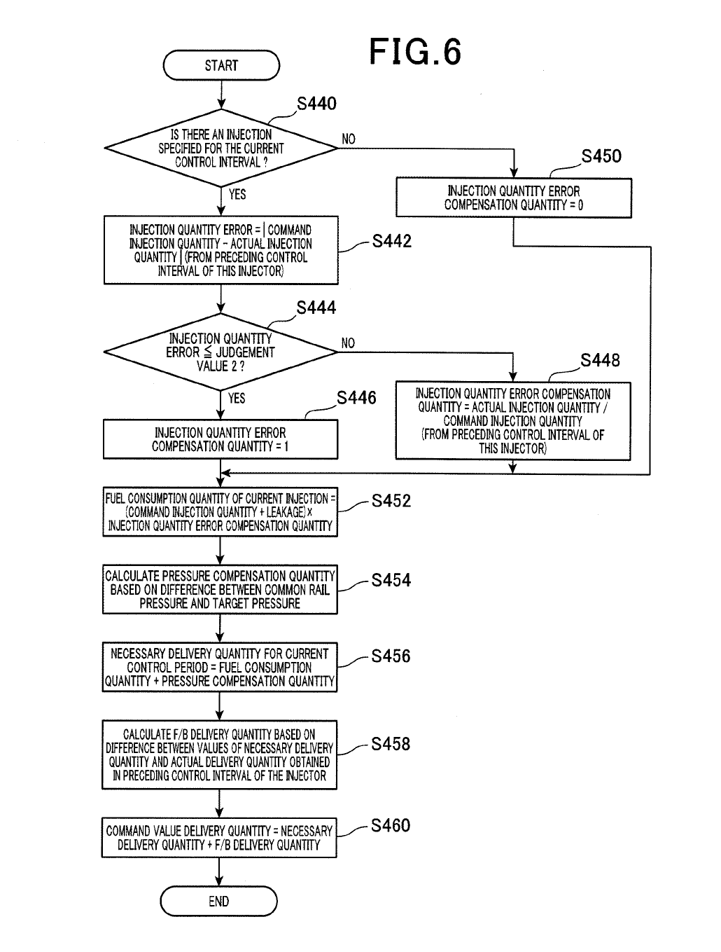

Pump control processing 3 will be described referring to the flow diagram of FIG. 6. Steps S440 and S454 to S460 are identical to steps S400 and S406 to S416 in the flow diagram of FIG. 4, so that description of these is omitted.

With this processing, as for the pump control processing 2 described above, the values of command injection quantity and actual injection quantity of a fuel injector 50 in the current control interval are respectively registered for use in the succeeding control interval of that injector 50.

If it is judged that there is no injection request for the fuel injector 50 in the current control interval (NO in step S440), the ECU 60 sets an injection quantity error compensation quantity to 0 (step S450) and step S452 is then executed.

If an injection will be executed by the fuel injector 50 in the current control interval (YES in step S440), the ECU 60 applies the following equation (3) to calculate the injection quantity error which occurred for the fuel injector 50 in the preceding control interval (step S442). A decision is then made as to whether the injection quantity error exceeds a predetermined value, designated as judgement value 2 (step S444). The injection quantity error calculated using equation (3) is the absolute difference between the values of command injection quantity and actual injection quantity (respectively obtained in the preceding control interval of the fuel injector 50), i.e.:

injection quantity error=|command injection quantity−actual injection quantity| (3)

If the injection quantity error is less than judgement value 2 (YES in step S444), it is judged that the fuel injector 50 is performing fuel injection normally, and the injection quantity error compensation quantity is set to 1 (step S446), and step S452 is then executed. If the injection quantity error is greater than judgement value 2 (NO in step S444), the ECU 60 applies equation (4) below to calculate the injection quantity error compensation quantity (step S448) and step S452 is then executed.

injection quantity error compensation quantity=actual injection quantity/command injection quantity (4)

In equation (4), the command injection quantity and the actual injection quantity are the respective values obtained for the fuel injector 50 in the preceding control interval of that injector 50.

With equation (4), if the actual injection quantity is less than the command injection quantity, the injection quantity error compensation quantity becomes less than 1, while if the actual injection quantity is greater than the command injection quantity, the injection quantity error compensation quantity becomes greater than 1.

In step S452, the ECU 60 applies equation (5) below to calculate (estimate) the fuel consumption quantity of the fuel injector 50 in the current control interval, then executes step S454.

Fuel consumption quantity=(command injection quantity+leakage quantity)×injection quantity error compensation quantity (5)

The reason for multiplying the sum of the command injection quantity and leakage quantity by the injection quantity error compensation quantity in equation (5) is that the leakage quantity is considered to vary in accordance with the ratio of the actual injection quantity to the command injection quantity.

With the pump control processing 3 of FIG. 6, if the fuel injector 50 corresponding to the current control interval executes a fuel injection in that control interval, the estimated fuel consumption quantity for that control interval is compensated based on the ratio of the command injection quantity to the actual injection quantity in the preceding control interval. As a result, even when there is an error between the command injection quantity and the actual injection quantity, the value of required delivery quantity for the common rail 40 (pumping quantity required to be delivered from the fuel supply pump 20) in the current control interval can be made highly accurate. Hence the fuel pumping quantities can be determined such that the common rail pressure is controlled to the target pressure value with a high degree of accuracy.

Furthermore if failure of the fuel injector 50 has occurred, such that no fuel was injected in the preceding control interval of that injector, the injection quantity error compensation quantity that is applied in equation (4) becomes 0. Thus the fuel consumption quantity obtained from equation (5) also becomes 0. Hence even when a fuel injector 50 is functioning abnormally and has ceased to perform fuel injections, accurate values of fuel consumption quantity of that injector can be estimated.

Furthermore, since compensation of a fuel consumption quantity is performed based on the ratio of a command injection quantity to the corresponding actual injection quantity, each fuel consumption quantity can be appropriately compensated irrespective of the magnitudes of the command injection quantity and the actual injection quantity.

With the pump control processing 3, in order to compensate each value of fuel consumption quantity of a fuel injector 50 with high accuracy, it is necessary to detect each actual injection quantity with a high degree of accuracy. This can be achieved, for example, by incorporating an internal pressure sensor in each injector 50, so that the fuel pressure within the fuel injector 50 at the time of a fuel injection can be detected with high accuracy, and hence the actual injection quantity can be accurately obtained.

### ALTERNATIVE EMBODIMENTS

The present invention is not limited to the above embodiment, and various modifications or alternative forms of the embodiment may be envisaged. For example, with the exhaust adjustment method of the above embodiment, the size of a pumping quantity delivered from the fuel supply pump 20 is determined (adjusted) by the timing at which the quantity pump control valve 30 of the fuel supply pump 20 is closed in the corresponding pumping action. However it would be equally possible to determine (adjust) the size of a pumping quantity by controlling the intake quantity of the fuel supply pump 20 in each suction action.

Furthermore with the above embodiment, there is one pumping quantity of fuel delivered by the fuel supply pump 20 for each injection operation of the engine 2. However it would be equally possible to employ a method whereby more than one pumping quantity is delivered by the fuel supply pump 20 for each fuel injection, e.g., two pumping quantities from the fuel supply pump 20 for each fuel injection.

Moreover with the pump control processing 2 of the above embodiment, instead of using the difference between the command injection quantity and actual injection quantity as a quantity indicative of the injection condition of a fuel injector 50, in each control interval of that injector 50, it would be equally possible to judge the injection condition of the fuel injector 50 based only on the actual injection quantity.

With respect to the appended claims, the respective functions of the injection condition detection means, the consumption quantity determining means, the compensation quantity determining means, the necessary delivery quantity determining means, the actual delivery quantity determining means, the feedback means and the pump control means recited in the claims, correspond to functions implemented by the ECU 60 of the above embodiment in executing a control program. However it would be equally possible to use hard-wired circuits (hardware) to implement one or more of these functions.

What is claimed is:

1. A pump control apparatus for application to a fuel supply system, the fuel supply system incorporating a fuel supply pump which impels fuel to a common rail to be stored under a common rail pressure and supplied from the common rail to respective injectors of an internal combustion engine, to be injected at injection timings respectively corresponding to the fuel injectors;
the pump control apparatus comprising:
injection condition detection means configured to detect respective injection conditions of the fuel injectors,
consumption quantity determining means configured to determine a fuel consumption quantity for each of the fuel injectors, at a current injection timing of the fuel injector, based on information including the injection condition of the fuel injector,
pressure compensation quantity determining means configured to determine a pressure compensation quantity prior to the current injection timing, based upon a difference between the common rail pressure and a target pressure value, as a fuel quantity required to be supplied to the common rail for setting the common rail pressure at a target pressure value,
necessary delivery quantity determining means configured to determine a necessary delivery quantity based upon a total of the fuel consumption quantity and the pressure compensation quantity, as a fuel quantity required to be impelled to the common rail from the fuel supply pump subsequent to the current injection timing for setting the common rail pressure at the target pressure value,
actual delivery quantity detection means configured to detect an actual delivery quantity as a quantity of fuel actually impelled from the fuel supply pump to the common rail,
feedback means configured for determining a feedback quantity based upon a difference between values of necessary delivery quantity and actual delivery quantity respectively corresponding to a preceding injection timing of the fuel injector,
command delivery quantity determining means configured for determining a command delivery quantity of fuel as a total of the feedback quantity and the necessary delivery quantity respectively corresponding to the current injection timing of the fuel injector, and
pump control means configured to control the fuel supply pump to impel the command delivery quantity of fuel into the common rail.

2. The pump control apparatus according to claim 1, wherein the consumption quantity determining means determines the fuel consumption quantity as being zero when the injection condition of the fuel injector has been detected as abnormal.

3. The pump control apparatus according to claim 1, wherein the consumption quantity determining means determines the fuel consumption quantity based upon the injection condition of the fuel injector in conjunction with a command injection quantity of fuel specified to be injected at the current injection timing.

4. The pump control apparatus according to claim 1, wherein the consumption quantity determining means determines the fuel consumption quantity based upon the injection condition of the fuel injector in conjunction with a total of a command injection quantity of fuel specified to be injected at the current injection timing and a leakage quantity of fuel.

5. The pump control apparatus according to claim 1, wherein the injection condition detection means is configured to detect actual injection quantities respectively corresponding to the injection timings of the fuel injector, as fuel quantities actually injected by the fuel injector, and to detect the injection condition of the fuel injector based upon the corresponding actual injection quantities.

6. The pump control apparatus according to claim 5, wherein the actual injection quantity corresponding to an injection is detected based on a quantity of change in speed of the internal combustion engine.

7. The pump control apparatus according to claim 5, wherein the injection condition detection means detects the injection condition of the fuel injector based on a magnitude of a corresponding actual injection quantity.

8. The pump control apparatus according to claim 5, wherein the injection condition detection means detects the injection condition of the fuel injector based on a difference between a command injection quantity specified for the fuel injector and a corresponding actual injection quantity.

9. The pump control apparatus according to claim 8, wherein the injection condition detection means
detects a difference between values of a command injection quantity and a corresponding actual fuel injection quantity respectively obtained for a preceding injection timing of the fuel injector,
determines the fuel consumption quantity corresponding to the current injection timing as being zero when the difference exceeds a predetermined judgement value, and
determines the fuel consumption quantity corresponding to the current injection timing based upon the command injection quantity corresponding to the current injection timing, when the difference does not exceed the judgement value.

10. The pump control apparatus according to claim 5, wherein the injection condition detection means detects the injection condition of the fuel injector based on a ratio of an actual injection quantity to a corresponding command injection quantity.

11. The pump control apparatus according to claim 10, wherein the injection condition detection means
detects an absolute difference between values of a command injection quantity and an actual fuel injection quantity respectively corresponding to a preceding injection timing of the fuel injector,
determines the fuel consumption quantity corresponding to the current injection timing based upon multiplying the command injection quantity for the current injection timing by a ratio of the precedingly obtained command injection quantity and actual injection quantity, when the absolute difference exceeds a predetermined judgement value, and
determines the fuel consumption quantity corresponding to the current injection timing based upon the command injection quantity corresponding to the current injection timing, when the absolute difference does not exceed the judgement value.

12. The pump control apparatus according to claim 1, wherein the injection condition detection means is configured to detect the injection condition of the fuel injector based on at least one of a condition of mechanical operation of the fuel injector and a condition of electrical operation of the fuel injector.

13. The pump control apparatus according to claim 12, wherein the injection condition detection means is configured to detect the injection condition of the fuel injector based on detection results corresponding to a preceding injection timing of the fuel injector.
